(19) United States
(12) Patent Application Publication
(10) Pub. No.: US 2022/0383842 A1
(43) Pub. Date: Dec. 1, 2022

(54) ESTIMATION MODEL CONSTRUCTION METHOD, PERFORMANCE ANALYSIS METHOD, ESTIMATION MODEL CONSTRUCTION DEVICE, AND PERFORMANCE ANALYSIS DEVICE

(71) Applicant: Yamaha Corporation, Hamamatsu (JP)

(72) Inventors: Shoken KANEKO, Yokohama (JP); Misa GOTO, Tokyo (JP); Akira MAEZAWA, Hamamatsu (JP)

(21) Appl. No.: 17/885,486

(22) Filed: Aug. 10, 2022

Related U.S. Application Data
(63) Continuation of application No. PCT/JP2021/001896, filed on Jan. 20, 2021.

(30) Foreign Application Priority Data
Feb. 17, 2020 (JP) 2020-023948

(51) Int. Cl. G10H 1/00

(52) U.S. Cl. CPC G10H 1/0025; G10H 2250/005

(57) ABSTRACT

An estimation model construction method realized by a computer includes preparing a plurality of training data that include first training data that include first feature amount data that represent a first feature amount of a performance sound of a musical instrument and first onset data that represent a pitch at which an onset exists, and second training data that include second feature amount data that represent a second feature amount of sound generated by a sound source of a type different than the musical instrument, and second onset data that represent that an onset does not exist, and constructing, by machine learning using the plurality of training data, an estimation model that estimates, from a feature amount data that represent a feature amount of a performance sound of the musical instrument, estimated onset data that represent a pitch at which an onset exists.

### CROSS-REFERENCE TO RELATED APPLICATIONS

This application is a continuation application of International Application No. PCT/JP2021/001896, filed on Jan. 20, 2021, which claims priority to Japanese Patent Application No. 2020-023948 filed in Japan on Feb. 17, 2020. The entire disclosures of International Application No. PCT/JP2021/001896 and Japanese Patent Application No. 2020-023948 are hereby incorporated herein by reference.

### BACKGROUND

### Technological Field

The present disclosure relates to technology for evaluating the performance of a musical instrument by a performer.

### Background Information

Various techniques for analyzing the performance of a musical instrument, such as a keyboard instrument, for example, have been proposed in the prior art. Japanese Laid-Open Patent Application No. 2017-215520 and Japanese Laid-Open Patent Application No. 2018-025613, for example, disclose techniques for identifying chords from performance sounds of a musical instrument.

In order to appropriately evaluate skills relating to the performance of a musical instrument, it is important accurately to estimate onsets (time points at which sound generation is initiated) in the performance. Conventional techniques for analyzing the performance of a musical instrument produce insufficient onset estimation accuracy; thus, it is required that analytical accuracy be improved.

### SUMMARY

According to one aspect of the present disclosure, An estimation model construction method realized by a computer comprises preparing a plurality of training data that include first training data that include first feature amount data that represent a first feature amount of a performance sound of a musical instrument and first onset data that represent a pitch at which an onset exists, and second training data that include second feature amount data that represent a second feature amount of sound generated by a sound source of a type different than the musical instrument, and second onset data that represent that an onset does not exist, and constructing, by machine learning using the plurality of training data, an estimation model that estimates, from a feature amount data that represent a feature amount of a performance sound of the musical instrument, estimated onset data that represent a pitch at which an onset exists.

According to another aspect of the present disclosure, a performance analysis method realized by a computer comprises sequentially estimating, from the feature amount data that represent the feature amount of the performance sound of a musical piece from the musical instrument, the estimated onset data, by using the estimation model constructed by the estimation model construction method, and analyzing a performance of the musical piece by matching music data that specify a time series of notes that constitute the musical piece and a time series of the estimated onset data estimated by the estimation model.

According to another aspect of the present disclosure, an estimation model construction device comprises an electronic controller including at least one processor, and the electronic controller is configured to execute a plurality of modules including a training data preparation module and an estimation model construction module. The training data preparation module is configured to prepare a plurality of training data that include first training data that include first feature amount data that represent a first feature amount of a performance sound of a musical instrument, and first onset data that represent a pitch at which an onset exists, and second training data that include second feature amount data that represent a second feature amount of a sound generated by a sound source of a type different than the musical instrument, and second onset data that represent that an onset does not exist. The estimation model construction module is configured to construct, by machine learning using the plurality of training data, an estimation model that estimates, from a feature amount data that represent a feature amount of a performance sound of the musical instrument, estimated onset data that represent a pitch at which an onset exists.

According to another aspect of the present disclosure, a performance analysis device comprises the electronic controller configured to further execute an onset estimation module configured to sequentially estimate, from the feature amount data that represent the feature amount of a performance sound of a musical piece from the musical instrument, the estimated onset data, by using the estimation model constructed by the estimation model construction device, and a performance analysis module configured to analyze a performance of the musical piece by matching music data that specify a time series of notes that constitute the musical piece and a time series of the estimated onset data estimated by the estimation model.

### BRIEF DESCRIPTION OF THE DRAWINGS

FIG. 1 is a block diagram illustrating the configuration of a performance analysis device.

FIG. 2 is a schematic diagram of a storage device.

FIG. 3 is a block diagram illustrating the functional configuration of the performance analysis device.

FIG. 4 is a schematic diagram of onset data.

FIG. 5 is a block diagram illustrating the configuration of a training data preparation module.

FIG. 6 is a flowchart illustrating the specific procedure of a learning process.

FIG. 7 is a schematic diagram of a performance screen.

FIG. 8 is an explanatory view of a first image.

FIG. 9 is an explanatory view of a second image.

FIG. 10 is a flowchart illustrating the specific procedure of performance analysis.

FIG. 11 is a schematic diagram of music data according to a second embodiment.

FIG. 12 is a flowchart illustrating the operation of a performance analysis module according to a second embodiment.

FIG. 13 is a diagram that explains the operation of a performance analysis device according to the second embodiment.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### A: FIRST EMBODIMENT

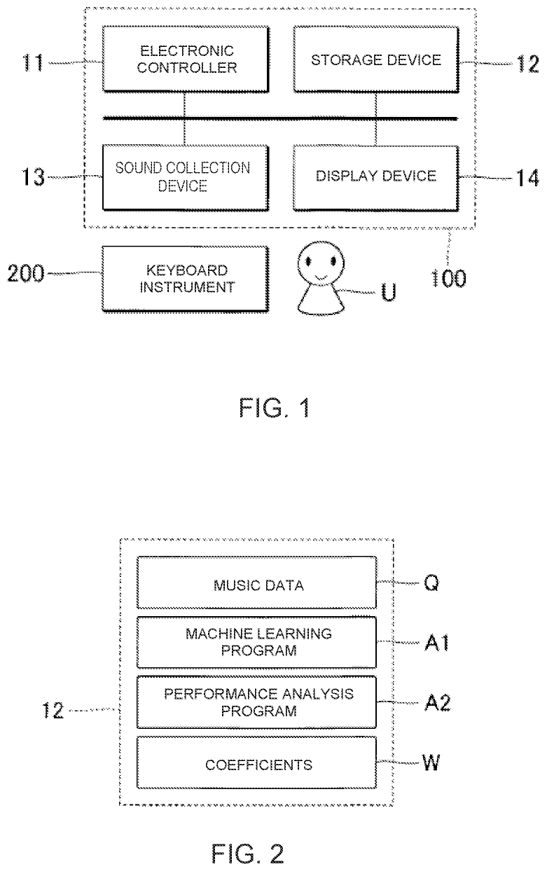

FIG. 1 is a block diagram showing the configuration of a performance analysis device 100 according to a first embodiment of the present disclosure. The performance analysis device 100 is a signal processing device that analyzes the performance of a keyboard instrument 200 by a performer U. The keyboard instrument 200 is a natural musical instrument that generates a performance sound in response to the pressing of a key by the performer U. The performance analysis device 100 is realized by a computer system comprising an electronic controller (control device) 11, a storage device 12, a sound collection device (sound collector) 13, and a display device (display) 14. The performance analysis device 100 is an information terminal such as a mobile phone, a smartphone, or a personal computer.

The electronic controller 11 includes one or a plurality of processors that control each element of the performance analysis device 100. For example, the electronic controller 11 includes one or more types of processors, such as a CPU (Central Processing Unit), an SPU (Sound Processing Unit), a DSP (Digital Signal Processor), an FPGA (Field Programmable Gate Array), an ASIC (Application-Specific Integrated Circuit), etc. The term “electronic controller” as used herein refers to hardware that executes software programs.

The display device 14 displays images under the control of the electronic controller 11. For example, the display device 14 displays the result of analyzing a performance of the keyboard instrument 200 performed by the performer U. The display device 14 is a display such as a liquid-crystal display panel or an organic EL (Electroluminescent) display panel.

The sound collection device 13 collects the performance sound emanated from the keyboard instrument 200 during the performance by the performer U and generates an audio signal V that represents a waveform of the performance sound. An illustration of an A/D converter that converts the audio signal V from analog to digital is omitted for the sake of convenience. The sound collection device 13 is a sound corrector such as a microphone.

The storage device 12 is one or a plurality of memory units (computer memories), each including a storage medium such as a magnetic storage medium or a semiconductor storage medium. A program that is executed by the electronic controller 11 and various data that are used by the electronic controller 11 are stored in the storage device 12. The storage device 12 can be formed by a combination of a plurality of types of storage media. Further, a portable storage medium that can be attached to/detached from the performance analysis device 100, or an external storage medium (for example, online storage) with which the performance analysis device 100 can communicate via a communication network can also be used as the storage device 12.

FIG. 2 is a schematic diagram of the storage device 12. Music data Q of a musical piece performed by the performer U with the keyboard instrument 200 is stored in the storage device 12. The music data Q specify a time series (that is, a musical score) of musical notes that constitute the musical piece. For example, time-series data that specify the pitch for each note are used as the music data Q. In other words, the music data Q are data that represent an ideal performance of the musical piece. Further, a machine learning program A1 and a performance analysis program A2 are stored in the storage device 12.

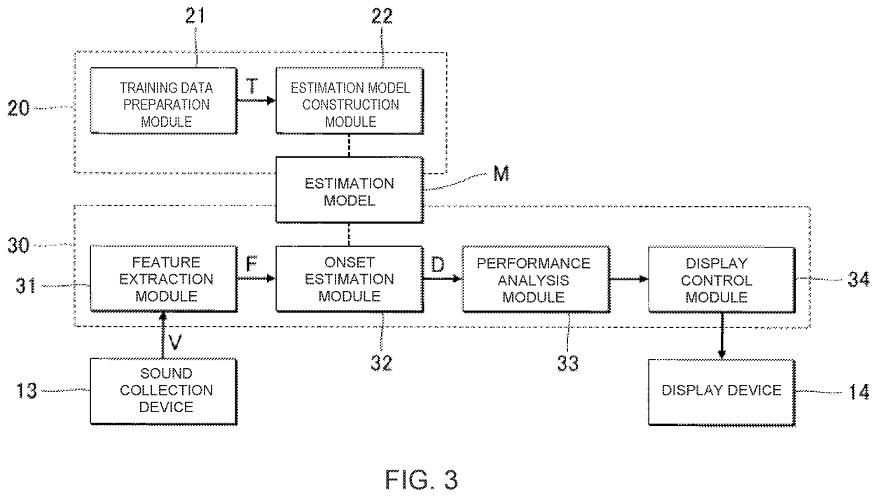

FIG. 3 is a block diagram illustrating the functional configuration of the electronic controller 11. The electronic controller 11 executes the machine learning program A1 and thus functions as a learning processing module 20. By machine learning, the learning processing module 20 constructs an estimation model M used for analyzing a performance sound of the keyboard instrument 200. Further, the electronic controller 11 executes the performance analysis program A2 and thus functions as an analysis processing module 30. The analysis processing module 30 uses the estimation model M constructed by the learning processing module 20 in order to analyze the performance of the keyboard instrument 200 performed by the performer U.

The analysis processing module 30 includes a feature extraction module 31, an onset estimation module 32, a performance analysis module 33, and a display control module 34. The feature extraction module 31 generates a time series of feature amount data F (F1, F2) from the audio signal V generated by the sound collection device 13. The feature amount data F represent the acoustic feature amount of the audio signal V. Generation of the feature amount data F is executed for each unit period (frame) on a time axis. The feature amount represented by the feature amount data F is, for example, the mel cepstrum. Known frequency analysis, such as a Short-time Fourier transform, is used for the generation of the feature amount data F by the feature extraction module 31.

The onset estimation module 32 estimates the onset in a performance sound from the feature amount data F. The onset corresponds to the starting point of each note of the musical piece. Specifically, the onset estimation module 32 generates, from the feature amount data F of each unit period, onset data D for each unit period. That is, the time series of the onset data D is estimated.

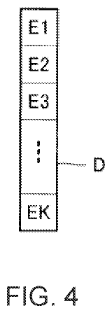

FIG. 4 is a schematic diagram of the onset data D. The onset data D is a K-dimensional vector composed of K elements E1-EK that correspond to different pitches. Each of the K pitches is a frequency defined by a prescribed temperament (typically, equal temperament). That is, each element Ek corresponds to a different pitch name distinguishing an octave in the temperament.

The element Ek corresponding to the kth (k=1−K) pitch in the onset data D of each unit period indicates in a binary manner whether or not the unit period corresponds to the onset of the pitch. Specifically, if the unit period corresponds to the onset of the kth pitch, the element Ek in the onset data D of the unit period is set to 1, and if the unit period does not correspond to the onset of the kth pitch, the element Ek is set to 0.

The estimation model M is used for the generation of the onset data D by the onset estimation module 32. The estimation model M is a statistical model for generating the onset data D in accordance with the feature amount data F. That is, the estimation model M is a learned model that has learned the relationship between the feature amount data F and the onset data D and that outputs a time series of the onset data D with respect to the time series of the feature amount data F.

The estimation model M is formed by a deep neural network, for example. Specifically, various neural networks such as a convolutional neural network (CNN) or a recursive neural network (RNN) are used as the estimation model M. Further, the estimation model M can include additional elements such as long short-term memory (LSTM) or ATTENTION.

The estimation model M is realized by combining a program that enables the electronic controller 11 to execute calculations for generating the onset data D from the feature amount data F, and a plurality of coefficients W (specifically, weighted value and bias) that are applied to the calculations. The plurality of coefficients W which define the estimation model M are set by machine learning (particularly, deep learning) by the learning processing module 20 described above. As shown in FIG. 2, the plurality of coefficients W are stored in the storage device 12.

The learning processing module 20 of FIG. 3 includes a training data preparation module 21 and an estimation model construction module 22. The training data preparation module 21 prepares a plurality of training data T. Each of the plurality of training data T are known data, in which the feature amount data F and the onset data D are associated with each other.

The estimation model construction module 22 constructs the estimation model M that estimates, from the feature amount data F, the onset data (estimated onset data) D, by supervised machine learning that uses the plurality of training data T. Specifically, the estimation model construction module 22 iteratively updates the plurality of coefficients W of the estimation model M, such that the error (loss function) between the onset data D that are generated by a provisional estimation model M from the feature amount data F of each training data T and the onset data D in the training data T is reduced. Thus, the estimation model M learns the latent relationship between the onset data D and the feature amount data F in the plurality of training data T. That is, the trained estimation model M outputs the statistically valid onset data D in terms of the relationship to the unknown feature amount data F.

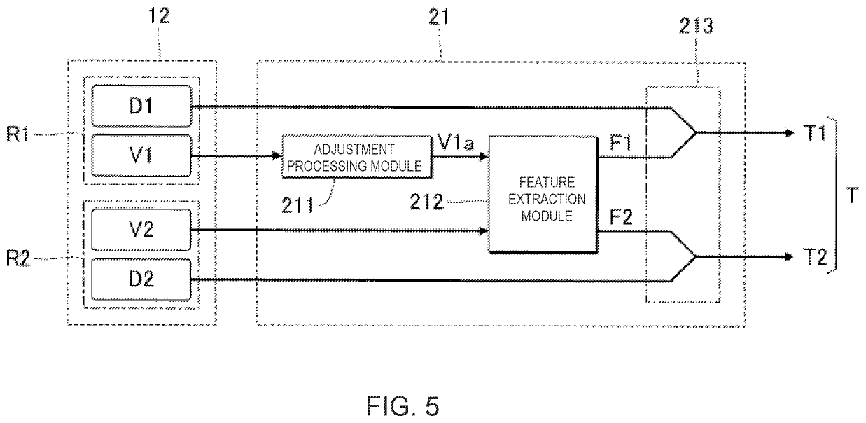

FIG. 5 is a block diagram illustrating a specific configuration of the training data preparation module 21. The training data preparation module 21 generates the plurality of training data T that include a plurality of first training data T1 and a plurality of second training data T2. A plurality of reference data R, which include a plurality of first reference data R1 and a plurality of second reference data R2, are stored in the storage device 12. The first reference data R1 are used for generating the first training data T1, and the second reference data R2 are used for generating the second training data T2.

Each piece of the plurality of first reference data R1 includes an audio signal V1 and onset data D1. The audio signal V1 is a signal that represents the performance sound of the keyboard instrument 200. The performance sounds of various musical pieces by numerous performers are pre-recorded, and the audio signal V1 that represents the performance sounds is stored in the storage device 12, together with the onset data D1, as the first reference data R1. The onset data D1 corresponding to the audio signal V1 are data that represent whether or not a sound of the audio signal V1 corresponds to an onset for each of K pitches. That is, each of the K elements E1-EK constituting the onset data D1 is set to 0 or 1.

Each piece of the plurality of second reference data R2 includes an audio signal V2 and onset data D2. The audio signal V2 represents sound generated by a different type of sound source than the keyboard instrument 200. Specifically, the audio signal V2 of the sound assumed to be present in a space in which the keyboard instrument 200 is actually played (hereinafter referred to as “ambient sound”) is stored. An ambient sound is, for example, ambient noise such as the sound of an air conditioner in operation, or various noises such as the sound of the human voice. Ambient sounds as exemplified above are pre-recorded, and the audio signal V2 that represents the ambient sounds is stored in the storage device 12, together with the onset data D2, as the second reference data R2. The onset data D2 are data that indicate that each of the K pitches does not correspond to an onset. That is, the K elements E1-EK constituting the onset data D2 are all set to 0.

The training data preparation module 21 includes an adjustment processing module 211, a feature extraction module 212, and a preparation processing module 213. The adjustment processing module 211 adjusts the audio signal V1 of each piece of the first reference data R1. Specifically, the adjustment processing module 211 applies a transmission characteristic C to the audio signal V1. The transmission characteristic C is a virtual frequency response that is assumed to have been applied by the time at which the performance sound of the keyboard instrument 200 reaches the sound collection device 13 (that is, the sound collection point) in the environment in which the keyboard instrument 200 is played. For example, the transmission characteristic C assumed for a typical or average acoustic space in which the performance sound of the keyboard instrument 200 is emanated and collected is applied to the audio signal V1. Specifically, the transmission characteristic C is represented by a specific impulse response. The adjustment processing module 211 convolves the impulse response with the audio signal V1 in order to generate an audio signal V1a.

The feature extraction module 212 generates feature amount data (a first feature amount data) F1 from the audio signal V1a after adjustment by the adjustment processing module 211 and generates feature amount data (a second feature amount data) F2 from the audio signal V2 of each piece of the second reference data R2. The feature amount data F1 and the feature amount data F2 represent the same type of feature amount (for example, mel cepstrum) as the above-mentioned feature amount data F.

The preparation processing module 213 generates the plurality of training data T, which include the plurality of first training data T1 and the plurality of second training data T2. Specifically, the preparation processing module 213 generates, from each piece of the plurality of first reference data R1, the first training data T1, which include the feature amount data F1 that is generated from the audio signal V1a, obtained by applying the transmission characteristic C to the audio signal V1 of the first reference data R1, and the onset data (first onset data) D1, which is also included in the first reference data R1. Further, the preparation processing module 213 generates, from each piece of the plurality of second reference data R2, the second training data T2, which include the feature amount data F2 that is generated from the audio signal V2 of the second reference data R2, and the onset data (second onset data) D2, which is also included in the second reference data R2.

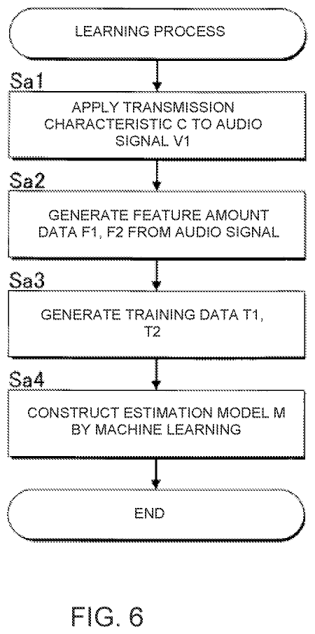

FIG. 6 is a flowchart illustrating the specific procedure of a process (hereinafter referred to as “learning process”) with which the learning processing module 20 constructs the estimation model M. When the learning process is started, the training data preparation module 21 prepares the plurality of training data T that include the first training data T1 and the second training data T2 (Sa1-Sa3). Specifically, the adjustment processing module 211 applies the transmission characteristic C to the audio signal V1 of each piece of the first reference data R1 in order to generate the audio signal V1a (Sa1). The feature extraction module 212 generates the feature amount data F1 from the audio signal V1a and generates the feature amount data F2 from the audio signal V2 of each piece of the second reference data R2 (Sa2). The preparation processing module 213 generates the first training data T1, which include the onset data D1 and the feature amount data F1, and the second training data T2, which include the onset data D2 and the feature amount data F2 (Sa3). The estimation model construction module 22 constructs the estimation model M by machine learning which uses the plurality of training data T (Sa4).

As can be understood from the foregoing explanation, in addition to the first training data T1, which include the feature amount data F1 that represent the feature amount of the performance sound of the keyboard instrument 200, the second training data T2, which include the feature amount data F2 that represent the feature amount of the sound generated by a different type of sound source from the keyboard instrument 200, are used for the machine learning of the estimation model M. Therefore, as compared with a case in which only the first training data T1 are used for the machine learning, it is possible to construct an estimation model M that can accurately generate the onset data D that represent the onset of the keyboard instrument 200. Specifically, the estimation model M is constructed such that it is unlikely that the sound generated by a sound source other than the keyboard instrument 200 is erroneously estimated as an onset of the keyboard instrument 200.

Further, the first training data T1 include the feature amount data F1 that represent the feature amount of the audio signal V1a to which the transmission characteristic C has been applied. In an actual analysis scenario, the transmission characteristic from the keyboard instrument 200 to the sound collection device 13 is applied to the audio signal V generated by the sound collection device 13. Thus, compared with a case in which the transmission characteristic C has not been applied, it is possible to construct the estimation model M that can estimate the onset data D that accurately represent whether or not each pitch corresponds to an onset.

To analyze the performance of the musical piece by the performer U, the performance analysis module 33, shown in FIG. 3, matches the music data Q to the time series of the onset data D. The display control module 34 controls the display device 14 to display the result of the analysis performed by the performance analysis module 33. FIG. 7 is a schematic view of a screen G (hereinafter referred to as “performance screen”) that is displayed by the display control module 34 on the display device 14. The performance screen is a coordinate plane (piano roll screen) on which the horizontal time axis Ax and a vertical pitch axis Ay are set.

The display control module 34 displays a note image Na that represents each note designated by the music data Q on the performance screen. The position of the note image Na in the direction of the pitch axis Ay is set in accordance with the pitch designated in the music data Q. The position of the note image Na in direction of the time axis Ax is set in accordance with the pronunciation period designated by the music data Q. In the initial stage immediately following the start of the performance of the musical piece, each note image Na is displayed in a first display mode. The display mode means the properties of the image that are visually distinguishable by the performer U. For example, in addition to the three attributes of color, hue (tone), saturation, and brightness (value), patterns and shapes are also included in the concept of the display mode.

The performance analysis module 33 advances a pointer P, which indicates one time point on the time axis Ax with respect to the musical piece represented by the music data Q in the positive direction of the time axis Ax at a prescribed speed. One or more notes (single notes or a chord) from among the time series of the notes in the musical piece to be played at one time point on the time axis are sequentially indicated by the pointer P. In accordance with the onset data D, the performance analysis module 33 determines whether or not the note (hereinafter the “target note”) indicated by the pointer P is sounded by the keyboard instrument 20. That is, it is determined whether the pitch of the target note corresponding to the time point indicated by the pointer P and the pitch corresponding to the onset represented by the onset data D are the same or different.

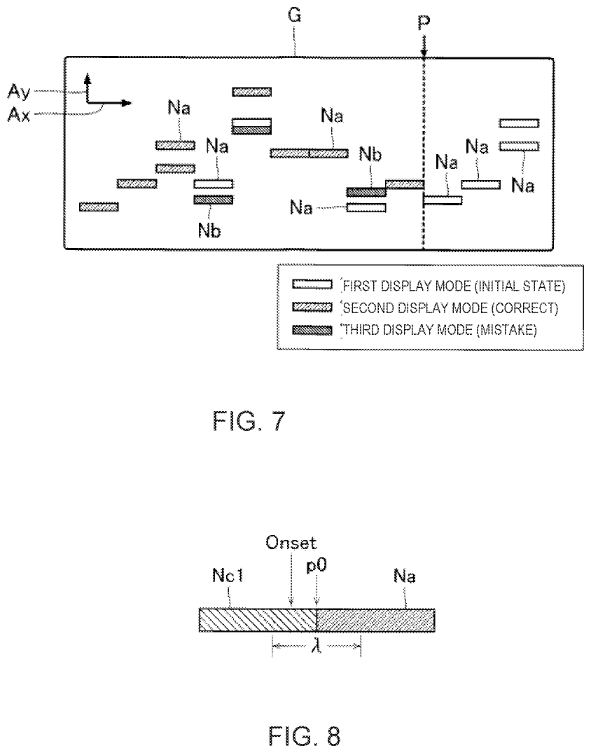

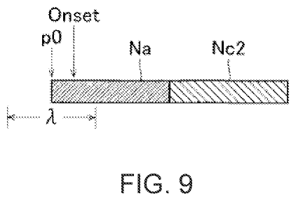

Further, the performance analysis module 33 determines whether the starting point of the target note is before or after the onset represented by the onset data D. Specifically, as shown in FIGS. 8 and 9, the performance analysis module 33 determines whether an onset is included in a permissible range λ that includes a starting point p0 of the target note. The permissible range λ is a range of prescribed width, with the starting point p0 of the target note at the midpoint, for example. The section length before the starting point p0 and the section length after the starting point p0 of the permissible range λ can be different.

If an onset with the same pitch as the target note exists at the starting point p0 of the target note (that is, if the target note has been accurately played), the display control module 34 changes the note image Na from the first display mode to the second display mode. For example, the display control module 34 changes the hue of the note image Na. If the performer U accurately plays the musical piece, each of the display modes of a plurality of the note images Na is changed from the first display mode to the second display mode as the musical piece progresses. In this way, the performer U can visually ascertain that he or she is playing each note of the musical piece accurately. In addition to the case in which the starting point p0 of the target note completely matches the time point of the onset, an onset can exist within a prescribed range that includes the starting point p0 (for example, a sufficiently narrower range as compared with the permissible range a) can also be determined as a case in which the target note has been played accurately.

On the other hand, in the case that an onset at the same pitch as the target note does not exist (that is, a case in which the target note is not played), the display control module 34 displays a performance mistake image Nb on the display device 14 while maintaining the note image Na in the first display mode. The performance mistake image Nb is an image that indicates a pitch (hereinafter referred to as an “incorrectly performed pitch”) that the performer U played in error. The performance mistake image Nb is displayed in a third display mode that is different from the first display mode and the second display mode. The position of the performance mistake image Nb in the pitch axis Ay direction is set in accordance with the incorrectly performed pitch. The position of the performance mistake image Nb in the time axis Ax direction is set in the same manner as for the note image Na of the target note.

That there is an onset at the same pitch as the target note within the permissible range λ but at a time point different from the starting point p0 of the target note indicates that the performance of the target note is ahead of or behind the starting point p0 of the target note. In the foregoing case, the display control module 34 changes the note image Na of the target note from the first display mode to the second display mode and displays a first image Nc1 or a second image Nc2 on the display device 14.

Specifically, as shown in FIG. 8, in the case that an onset is located before the starting point p0 of the target note within the permissible range λ, the display control module 34 displays the first image Nc1 in the negative direction of the time axis Ax (that is, on the left side) with respect to the note image Na of the target note. The first image Nc1 is an image that indicates that the onset of the performance by the performer U leads the starting point p0 of the target note. On the other hand, as shown in FIG. 9, in the case that an onset is located after the starting point p0 of the target note within the permissible range λ, the display control module 34 displays the second image Nc2 in the positive direction of the time axis Ax (that is, on the right side) with respect to the note image Na of the target note. The second image Nc2 is an image that indicates that the onset of the performance by the performer U lags the starting point p0 of the target note. As described above, according to the first embodiment, the performer U can visually ascertain whether the performance of the keyboard instrument 200 is early or late with respect to an ideal performance. The display mode of the first image Nc1 and the display mode of the second image Nc2 can be the same or different. The first image Nc1 and the second image Nc2 can be displayed in display modes that are different than those of the first display mode and the second display mode.

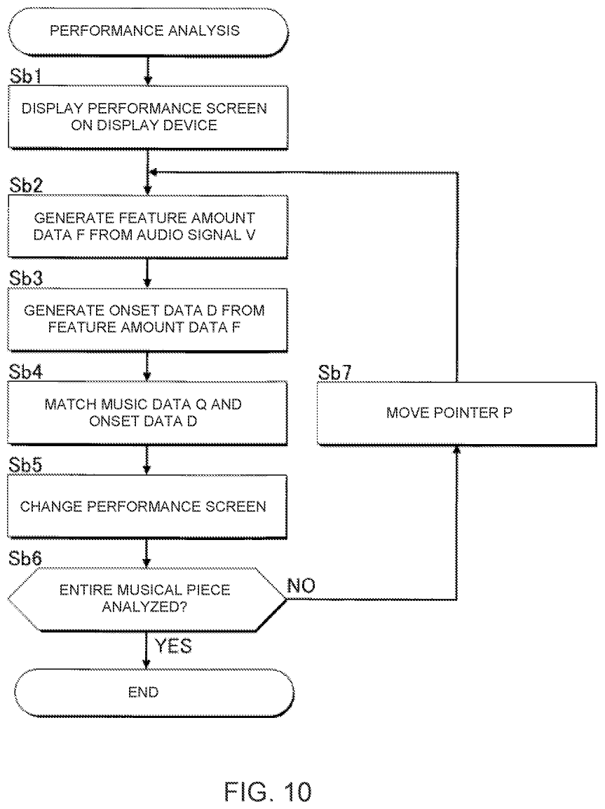

FIG. 10 is a flowchart illustrating the specific procedure of a process (hereinafter referred to as “performance analysis”) in which the analysis processing module 30 analyzes the performance of the musical piece by the performer U. For example, the process of FIG. 10 is initiated by an instruction from the performer U. When the performance analysis starts, the display control module 34 displays an initial performance screen that represents the content of the music data Q (Sb1) on the display device 14.

The feature extraction module 31 generates the feature amount data F that represent the features of the unit period that correspond to the pointer P in the audio signal V (Sb2). The onset estimation module 32 inputs the feature amount data F into the estimation model M in order to generate the onset data D (Sb3). The performance analysis module 33 matches the music data Q and the onset data D in order to analyze the performance of the musical piece by the performer U (Sb4). The display control module 34 changes the performance screen in accordance with the result of the analysis by the performance analysis module 33 (Sb5).

The performance analysis module 33 determines whether the performance of the entire musical piece has been analyzed (Sb6). If the performance of the entire musical piece has not been analyzed (Sb6: NO), the performance analysis module 33 moves the pointer P in the positive direction of the time axis Ax by a prescribed amount (Sb7) and the process proceeds to Step Sb2. That is, following the movement of the pointer P, the generation of the feature amount data F (Sb2), the generation of the onset data D (Sb3), the analysis of the performance (Sb4), and the changing of the performance screen (Sb5) are executed for the time point indicated by the pointer. Once the performance of the entire musical piece has been analyzed (Sb6: YES), the performance analysis process comes to an end.

As described above, in the first embodiment, since the feature amount data F that represent the feature amount of the performance sound of the keyboard instrument 200 are input into the estimation model M in order to estimate the onset data D that indicate whether or not each pitch corresponds to an onset, it is possible to analyze with great accuracy whether the time series of notes designated by the music data Q is being played correctly.

### B: SECOND EMBODIMENT

The second embodiment will be described. In each of the embodiments described below, elements with functions common to those of the first embodiment have been assigned the same reference numerals that were used in the first embodiment and their detailed descriptions have been appropriately omitted.

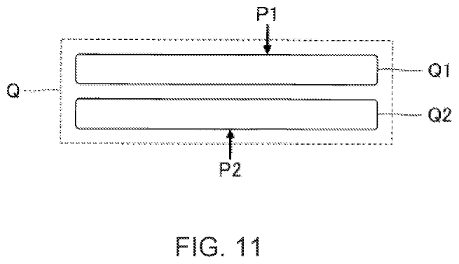

FIG. 11 is a schematic diagram of the music data Q according to the second embodiment. The music data Q include first data Q1 and second data Q2. The first data Q1 specify, from a plurality of performance parts constituting a musical piece, a time series of notes that constitute a first performance part. The second data Q2 specify, from the plurality of performance parts constituting the musical piece, a time series of notes that constitute a second performance part. Specifically, the first performance part is the part performed with the right hand of the performer U. The second performance part is the part performed with the left hand of the performer U.

In the first embodiment, a configuration was described in which the pointer P is advanced at a prescribed speed. In the performance analysis of the second embodiment, a first pointer P1 and a second pointer P2 are set separately. The first pointer P1 indicates one time point on the time axis in the first performance part, and the second pointer P2 indicates one time point on the time axis in the second performance part. The first pointer P1 and the second pointer P2 are advanced at a variable speed in accordance with the performance of the musical piece by the performer U. Specifically, the first pointer P1 advances to the time point of the note each time the performer U plays a note of the first performance part, and the second pointer P2 advances to the time point of the note each time the performer U plays a note of the second performance part.

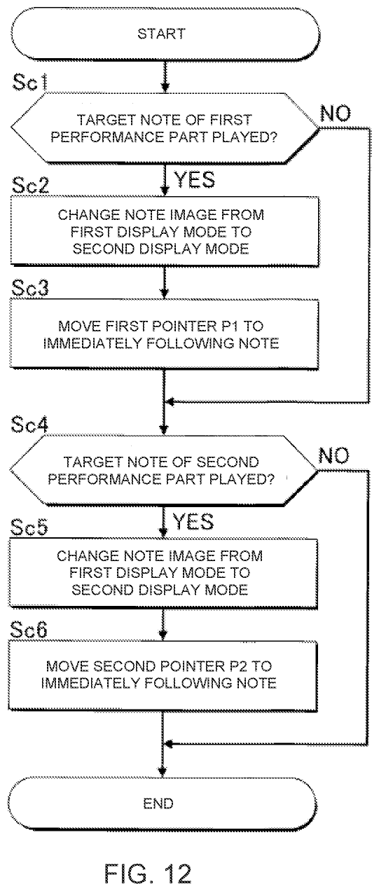

FIG. 12 is a flowchart showing the specific procedure of the process with which the performance analysis module 33 analyzes a performance in the second embodiment. The process of FIG. 12 is repeated at prescribed intervals. The performance analysis module 33 determines in accordance with the onset data D whether the target note indicated by the first pointer P1, from the time series of notes designated by the music data Q with respect to the first performance part, has been played by the keyboard instrument 200 (Sc1). If the note indicated by the first pointer P1 is played (Sc1: YES), the display control module 34 changes the display mode of the note image Na of the target note from the first display mode to the second display mode (Sc2). The performance analysis module 33 moves the first pointer P1 to the note immediately following the current target note in the first performance part (Sc3). On the other hand, if the target note indicated by the first pointer P1 is not played (Sc1: No), the changing of the display mode of the note image Na (Sc2) and the moving of the first pointer P1 (Sc3) are not executed.

When the foregoing process is executed, the performance analysis module 33 determines, in accordance with the onset data D, whether the target note indicated by the second pointer P2, from the time series of notes specified by the music data Q with respect to the second performance part, has been played by the keyboard instrument 200 (Sc4). If the note indicated by the second pointer P2 is played (Sc4: YES), the display control module 34 changes the display mode of the note image Na of the target note from the first display mode to the second display mode (Sc5). The performance analysis module 33 moves the second pointer P2 to the note immediately following the current target note in the second performance part (Sc6). On the other hand, if the target note indicated by the second pointer P2 is not played (Sc4: NO), the changing of the display mode of the note image Na (Sc5) and the moving of the second pointer P2 (Sc6) are not executed.

As can be understood from the foregoing explanation, whether or not the keyboard instrument 200 has been played is determined for the first performance part and the second performance part separately, and the first pointer P1 and the second pointer P2 proceed independently of each other, in accordance with the result of each determination.

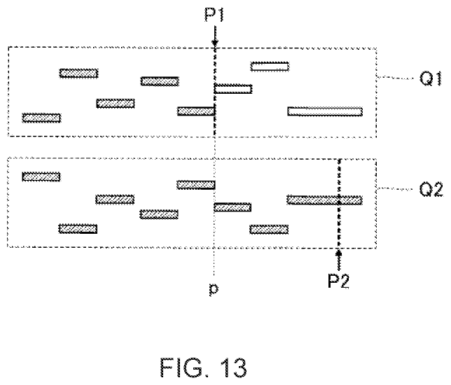

For example, as shown in FIG. 13, a case is assumed in which the performer U is unable to play a note of the first performance part that corresponds to a time point p. It is assumed that the performer U plays the first performance part and the second performance part in parallel and is able to play each note of the second performance part that follows time point p correctly. In this state, the first pointer P1 is held at the note corresponding to time point p, whereas the second pointer P2 proceeds past the time point p. Thus, if the performer U replays the first performance part from time point p where the first performance part was played in error, the performer need not replay the second performance part from the time point p. Therefore, compared with a case in which both the first performance part and the second performance part must be replayed from the time point p where the first performance part was played in error, the performance burden on the performer U can be reduced.

### C: THIRD EMBODIMENT

In the first embodiment, K pitches that distinguish an octave were used as an example. The K pitches of the third embodiment are chromas that do not distinguish an octave under a prescribed temperament. That is, a plurality of pitches whose frequencies differ at one octave units (that is, having common pitch names) belong to any one chroma. Specifically, the onset data D of the third embodiment are composed of 12 elements Ek (K=12), respectively corresponding to 12 chromas (pitch names) defined by equal temperament. The element Ek corresponding to the kth chroma in the onset data D for each unit period represents whether or not the unit period corresponds in a binary manner to the onset of the chroma. Because a plurality of pitches that belong to different octaves are included in one chroma, a numerical value of 1 of the element Ek corresponding to the kth chroma means that any one of the plurality of pitches corresponding to the chroma has been sounded.

The onset data D exemplified above are used for the training data T used for the machine learning of the estimation model M, and the estimation model M outputs the onset data D exemplified above. By the configuration described above, as compared with a configuration (for example, the first embodiment) in which the onset data D indicated whether or not the unit period corresponds to an onset for each of the K pitches that distinguish an octave, the data amount of the onset data D is reduced. Thus, there is the advantage that the size of the estimation model M and the time required for the machine learning of the estimation model M are reduced.

The performance analysis module 33 determines whether the chroma to which the pitch of the target note indicated by the pointer P belongs and the chroma corresponding to the onset indicated by the onset data D are the same or different. If the chroma of the target note and the chroma of the onset match (that is, if the same chroma as that of the target note was accurately played), the display control module 34 changes the note image Na from the first display mode to the second display mode. On the other hand, if the chroma of the target note and the chroma of the onset differ (if a different chroma from that of the target note was played), the performance analysis module 33 specifies the incorrectly performed pitch that was erroneously played by the performer U.

A chroma that is erroneously played by the performer U (hereinafter referred to as “incorrectly performed chroma”) is specified from the onset data D, but it is not possible to uniquely identify the incorrectly performed pitch from among the plurality of pitches to which the incorrectly performed chroma belongs from only the onset data D. Thus, the performance analysis module 33 references the relationship between the plurality of pitches belonging to the incorrectly performed chroma and the pitch of the target note in order to identify the incorrectly performed pitch. Specifically, from the plurality of pitches belonging to the incorrectly performed chroma, the performance analysis module 33 identifies the pitch closest to the pitch of the target note (that is, the pitch with the smallest pitch that differs than that of the target note) as the incorrectly performed pitch. As described above with reference to FIG. 7, the display control module 34 displays the performance mistake image Nb indicating the incorrectly performed pitch on the display device 14. In the same manner as in the first embodiment, the position of the performance mistake image Nb in the direction of the pitch axis Ay is set in accordance with the incorrectly performed pitch.

The same effects as those of the first embodiment are realized in the third embodiment. Further, in the third embodiment, if the chroma of the target note and the chroma of the onset differ, the incorrectly performed pitch that is closest to the pitch of the target note out of the plurality of pitches belonging to the chroma of the onset is identified. The performance mistake image Nb (performance image) is then displayed at the position on the pitch axis Ay that corresponds to the incorrectly performed pitch. Therefore, the performer U can visually confirm the pitch that was played incorrectly.

### D: MODIFICATION

Specific modifications added to each of the above-mentioned embodiment examples are described below. Two or more embodiments arbitrarily selected from the following examples can be appropriately combined insofar as they are not mutually contradictory.

(1) In the first embodiment, a configuration was described in which the pointer P advances at a prescribed speed; and in the third embodiment, a configuration was described in which the pointer P advances for each performance by the performer U. The performance analysis device 100 can operate in any of the operating modes including that in which the pointer P advances at a prescribed speed and an operating mode in which the pointer P advances for each performance by the performer U. The operating mode is selected in accordance with an instruction from the performer U, for example.

(2) In each of the above-mentioned embodiments, onset data D indicating whether or not each unit period corresponds to an onset for each of K pitches (including chromas) were used as an example, but the format of the onset data D is not limited to the examples described above. For example, onset data D that indicate the number of the pitch out of K pitches that was sounded can be generated by the estimation model M. As can be understood from the foregoing explanation, the onset data D are comprehensively expressed as data that represent the pitch in which an onset exists.

(3) In each of the embodiments described above, the performance mistake image Nb is displayed on the display device 14 when the performer U played a pitch that differs from the pitch of the target note, but the configuration for notifying the performer U of an incorrect performance is not limited to the example described above. For example, when the performer U makes a mistake during the performance, a configuration in which the display mode of the entire performance screen is temporarily changed (for example, a configuration in which the entire performance screen is illuminated) or a configuration in which a sound effect indicating an incorrect performance can be assumed.

(4) In the second embodiment, an example was used in which the musical piece is composed of the first performance part and the second performance part, but the total number of performance parts constituting the musical piece is arbitrary. A pointer P is set for each performance part, and the pointer P of each performance part advances independently of the other parts. Moreover, each of a plurality of performance parts can be played by different performers U using different musical instruments.

(5) In each of the above-described embodiments, the performance of the keyboard instrument 200 is assumed, but the type of musical instrument played by the performer U is not limited to the keyboard instrument 200. For example, the present disclosure can be applied to analyze the performance of a musical instrument such as a wind instrument or a string instrument. In each of the embodiments described above, an example was used in which the audio signal V generated by the sound collection device 13 is processed by collecting the performance sound emitted from the musical instrument. Further, the present disclosure can be applied to the analysis of the performance of an electric musical instrument (for example, an electric guitar) that generates an audio signal V in accordance with its performance by a performer U. In the case that the performer U plays an electric musical instrument, the audio signal V generated by the electric musical instrument is processed. Thus, the sound collection device 13 can be omitted.

(6) In each of the embodiments described above, the first reference data R1, which include the audio signal V1 that represents the performance sound of the keyboard instrument 200, and the second reference data R2, which include the audio signal V2 that represents the sound generated by a different type of sound source from the keyboard instrument 200, are used to generate the plurality of training data T. However, reference data R, which include an audio signal V that represents a mixture of the performance sound of the keyboard instrument 200 and sound generated by a different type of sound source than the keyboard instrument 200 can be used to generate the training data T. For example, in addition to the performance sound of the keyboard instrument 200, the sound represented by the audio signal V of the reference data R can include ambient noise, such as the sound of an air conditioner, or various noises such as the sound of the human voice. As can be understood from the foregoing explanation, a configuration in which the reference data R that are used for generating the training data T are analyzed into first reference data R1 and second reference data R2 is not essential.

(7) Each of the following configurations of the embodiments described above can be established independently of the other configurations. Configuration 1: A configuration in which the plurality of training data T that include the first training data T1 and the second training data T2 are used for the machine learning of the estimation model M. Configuration 2: a configuration in which the training data T, which include the feature amount data F1 that is generated from the audio signal V1a, obtained by convolution with the transmission characteristic C, are used for the machine learning of the estimation model M. Configuration 3: the first pointer P1 of the first performance part and the second pointer P2 of the second performance part are advanced independently of each other in accordance with the performance of each performance part. Configuration 4: a configuration in which, if the onset is located before the starting point of the target note, the first image Nc1 is displayed in the negative direction of the time axis Ax with respect to the note image Na; and if the onset is located after the starting point of the target note, the second image Nc2 is displayed in the positive direction of the time axis Ax with respect to the note image Na. Configuration 5: a configuration in which, if the chroma of the target note and the chroma of the onset differ, then, from the plurality of pitches belonging to the chroma of the onset, the pitch closest to the pitch of the target note is identified.

(8) In each of the embodiments presented above, the performance analysis device 100, which includes both the learning processing module 20 and the analysis processing module 30, was described in terms of an example, but the learning processing module 20 can be omitted from the performance analysis device 100. Further, the present disclosure is also specified as an estimation model construction device that includes the learning processing module 20. The estimation model construction device is also referred to as a machine learning device that constructs the estimation model M by machine learning. The presence or absence of the analysis processing module 30 in the estimation model construction device is immaterial, and the presence or absence of the learning processing module 20 in the performance analysis device 100 is also immaterial.

(9) As explained in the foregoing, the functions of the performance analysis device 100, described above in terms of examples, are realized by the interactive cooperation between one or a plurality of processors that constitute the electronic controller 11 and a program (machine learning program A1 or performance analysis program A2) stored in the storage device 12. The program according to the present disclosure can be provided in a form stored in a computer-readable storage medium and installed in a computer. The storage medium is, for example, a non-transitory storage medium, a good example of which is an optical storage medium (optical disc) such as a CD-ROM, but can include storage media of any known form, such as a semiconductor storage medium or a magnetic storage medium. Non-transitory storage media include any storage medium that excludes the transitory propagation of signals and does not exclude volatile storage media. Further, in a configuration in which a distribution device distributes the program via a communication network, a storage device that stores the program in the distribution device corresponds to the non-transitory storage medium.

### E: ADDITIONAL STATEMENT

For example, the following configurations may be understood from the foregoing embodiment examples.

An estimation model construction method according to one aspect of (first aspect) the present disclosure is an estimation model construction method for estimating, from feature amount data that represent a feature amount of a performance sound of a musical instrument, onset data that represent the pitch at which an onset exists, comprising preparing a plurality of training data, which include first training data that include feature amount data that represent the feature amount of a performance sound of the musical instrument and onset data that represent the pitch at which an onset exists and second training data that include feature amount data that represent the feature amount of sound generated by a sound source of a type that differs from the musical instrument, and onset data that indicate that an onset does not exist; and constructing the estimation model by machine learning using the plurality of training data. In the aspect described above, in addition to the first training data, which include feature amount data that represent the feature amount of the performance sound of the musical instrument, the second training data, which include feature amount data that represent the feature amount of the sound generated by a different type of sound source from the musical instrument, are used for the machine learning of the estimation model. Therefore, compared with the case in which only the first training data are used for the machine learning, it is possible to construct an estimation model that can estimate the onset data that represent the pitch at which the onset exists with high accuracy. Specifically, an estimation model is constructed in which it is unlikely that the sound generated by a sound source other than a musical instrument is incorrectly estimated as an onset of a musical instrument.

In a specific example (second aspect) of the first aspect, in the preparation of the training data, the transmission characteristic from the musical instrument to the sound collection point is applied to the audio signal, which represents the performance sound of a musical instrument; and the feature amount data, which represent the feature amount extracted from the audio signal after application and the first training data, which include onset data that represent the pitch at which an onset exists are prepared. In the aspect described above, the first training data include the feature amount data that represent the feature amount of the audio signal to which the transmission characteristic, from the musical instrument to the sound collection point, is applied. Therefore, compared with a case in which the transmission characteristic has not been applied, it is possible to construct the estimation model that can estimate the onset data that accurately represent the pitch at which the onset exists.

A performance analysis method according to one aspect (third aspect) of the present disclosure uses an estimation model constructed by the estimation model construction method according to the first or the second aspect in order to sequentially estimate onset data that represent the pitch at which an onset exists from feature amount data that represent the feature amount of the performance sound of a musical piece made by a musical instrument, and matches music data that specify a time series of notes constituting the musical piece and a time series of the onset data estimated by the estimation model in order to analyze the performance of the musical piece. By the aspect described above, an estimation model generated by machine learning utilizing the second training data that include the feature amount data of sound generated by a sound source of a type different than the musical instrument is used to estimate the onset data that represent the pitch at which an onset exists, so that it is possible to accurately analyze whether or not the time series of notes specified by the music data is being played correctly.

In a specific example (fourth aspect) of the third aspect, the music data specify a time series of notes constituting a first performance part of the musical piece and a time series of notes constituting a second performance part of the musical piece, and, in the analysis of the performance, whether or not a note, from among the time series of notes specified by the music data with respect to the first performance part, which was indicated by a first pointer was sounded by the musical instrument is determined in accordance with the onset data, and if the determination result is affirmative, the first pointer is advanced to the next note in the first performance part; and whether or not a note, from among the time series of notes specified by the music data with respect to the second performance part, which was indicated by a second pointer was sounded by the musical instrument is determined in accordance with the onset data, and if the determination result is affirmative, the second pointer is advanced to the next note in the second performance part. By the aspect described above, whether or not the first performance part and the second performance part have been played by the musical instrument is individually determined for each part, and the first pointer and the second pointer both proceed independently, in accordance with the result of each determination. Therefore, in the case that the first performance part was performed incorrectly but the second performance part was performed correctly, if the first performance part is replayed from the time point where the first performance part was played incorrectly, the second performance part need not be replayed from the aforementioned time point.

In a specific example (fifth aspect) of the third aspect, in the analysis of the performance, whether or not a pitch of a target note, which is one note specified by the music data, and a pitch corresponding to an onset, which is represented by the onset data, are the same or different, and whether or not a starting point of the target note is before or after the onset are determined; a note image that represents the target note is displayed on a score area in which a time axis and a pitch axis are set, wherein if the onset is located before the starting point of the target note, a first image is displayed in the negative direction of the time axis with respect to the note image, and if the onset is located after the starting point of the target note, a second image is displayed in a positive direction of the time axis with respect to the note image. By the aspect described above, if the onset is located before the starting point of the target note, the first image is displayed in the negative direction of the time axis with respect to the note image, and if the onset is located after the starting point of the target note, the second image is displayed in the positive direction of the time axis with respect to the note image. Therefore, the performer of the musical instrument can visually ascertain whether his or her performance is early or late with respect to an ideal performance.

In a specific example (sixth aspect) of the fifth aspect, the onset data indicate whether or not each of a plurality of chromas as the plurality of pitches corresponds to an onset, and if a chroma corresponding to the pitch of the target note and a chroma related to an onset represented by the onset data differ, a performance image corresponding to the onset is displayed at a position on the pitch axis that corresponds to the pitch, from a plurality of pitches belonging to the chroma relating to the onset, which is closest to the pitch of the target note. By the aspect described above, since onset data that indicate whether or not each of a plurality of chromas corresponds to an onset is used, compared with a configuration in which the onset data indicate whether or not each of a plurality of pitches that are distinguished between octaves, for example, corresponds to an onset, the amount of the octave data is reduced. Therefore, there is the advantage that the size of the estimation model and the time required for the machine learning of the estimation model are reduced. On the other hand, if a chroma corresponding to the pitch of the target note and a chroma related to an onset represented by the onset data differ, a performance image is displayed at a position on the pitch axis that corresponds to the pitch closest to the pitch of the target note, so that the performer can visually confirm the pitch that was played incorrectly.

An estimation model construction device according to one aspect (seventh aspect) of the present disclosure constructs an estimation model for estimating, from feature amount data that represent the feature amount of a performance sound of a musical instrument, onset data that represent the pitch at which an onset exists, comprising a training data preparation unit that prepares a plurality of training data, and an estimation model construction unit that constructs the estimation model by machine learning using the plurality of training data, wherein the training data preparation unit prepares a plurality of training data, which include first training data, which include feature amount data that represent the feature amount of a performance sound of the musical instrument, and onset data that represent the pitch at which an onset exists, and second training data, which include feature amount data that represent the feature amount of sound generated by a sound source of a type different than the musical instrument, and onset data that indicate that an onset does not exist.

A performance analysis device according to one aspect (eighth aspect) of the present disclosure comprises an onset estimation unit that uses an estimation model constructed by the estimation model construction device according to the seventh aspect in order to sequentially estimate, from feature amount data that represent the feature amount of the performance sound of a musical piece made by a musical instrument, onset data that represent the pitch at which an onset exists, and a performance analysis unit that matches music data that specify the time series of notes that constitutes the musical piece and the time series of the onset data estimated by the estimation model in order to analyze the performance of the musical piece.

A program according to one aspect (ninth aspect) of the present disclosure is a program for constructing an estimation model for estimating, from feature amount data that represent the feature amount of a performance sound of a musical instrument, onset data that represent the pitch at which an onset exists, enables a computer to function as a training data preparation unit that prepares a plurality of training data, and an estimation model construction unit that constructs the estimation model by machine learning using the plurality of training data, wherein the training data preparation unit prepares a plurality of training data, which include first training data that include the feature amount data that represent a feature amount of the performance sound of the musical instrument, and onset data that represent the pitch at which an onset exists, and second training data, which include feature amount data that represent the feature amount of sound generated by a sound source of a type different than the musical instrument, and onset data that indicate that an onset does not exist.

A program according to one aspect (tenth aspect) of the present disclosure enables a computer to function as an onset estimation unit that uses an estimation model constructed by the estimation model construction device according to the ninth aspect in order to sequentially estimate, from feature amount data that represent the feature amount of the performance sound of a musical piece made by a musical instrument, onset data that represent the pitch at which an onset exists, and a performance analysis unit that matches music data that specify the time series of notes that constitute the musical piece and the time series of the onset data estimated by the estimation model in order to analyze the performance of the musical piece.

What is claimed is:

1. An estimation model construction method realized by a computer, the estimation model construction method comprising:
preparing a plurality of training data that include
first training data that include first feature amount data that represent a first feature amount of a performance sound of a musical instrument and first onset data that represent a pitch at which an onset exists, and
second training data that include second feature amount data that represent a second feature amount of sound generated by a sound source of a type different than the musical instrument, and second onset data that represent that an onset does not exist; and
constructing, by machine learning using the plurality of training data, an estimation model that estimates, from a feature amount data that represent a feature amount of a performance sound of the musical instrument, estimated onset data that represent a pitch at which an onset exists.

2. The estimation model construction method according to claim 1, wherein
the plurality of training data is prepared such that by applying, to an audio signal that represents the performance sound of the musical instrument, a transmission characteristic from the musical instrument to a sound collection point, the first training data includes the first feature amount data that represent the first feature amount extracted from the audio signal after the applying and the first onset data.

3. A performance analysis method realized by a computer, the performance analysis method comprising:
sequentially estimating, from the feature amount data that represent the feature amount of the performance sound of a musical piece from the musical instrument, the estimated onset data, by using the estimation model constructed by the estimation model construction method according to claim 1; and
analyzing a performance of the musical piece by matching music data that specify a time series of notes that constitute the musical piece and a time series of the estimated onset data estimated by the estimation model.

4. The performance analysis method according to claim 3, wherein
the music data specify a time series of notes that constitute a first performance part of the musical piece and a time series of notes that constitute a second performance part of the musical piece, and
in the analyzing of the performance,
determination whether or not a note indicated by a first pointer, in the time series of notes specified by the music data with respect to the first performance part, has been sounded by the musical instrument is performed in accordance with the estimated onset data, and in response to an affirmative result of the determination, the first pointer is advanced to a next note of the first performance part, and
determination whether or not a note indicated by a second pointer, in the time series of notes specified by the music data with respect to the second performance part, has been sounded by the musical instrument is performed in accordance with the estimated onset data, and in response to an affirmative result of the determination, the second pointer is advanced to a next note of the second performance part.

5. The performance analysis method according to claim 3, wherein
in the analyzing of the performance, whether or not a pitch of a target note, which is one note specified by the music data, and a pitch that corresponds to an onset represented by the estimated onset data are the same or different, and whether a starting point of the target note is before or after the onset represented by the estimated onset data are determined, and
the performance analysis method further comprises
displaying a note image that represents the target note in a score area in which a time axis and a pitch axis are set, and
displaying a first image in a negative direction of the time axis with respect to the note image upon determining that the onset represented by the estimated onset data is located before the starting point of the target note, and displaying a second image in a positive direction of the time axis with respect to the note image upon determining that the onset represented by the estimated onset data is located after the starting point of the target note.

6. The performance analysis method according to claim 3, wherein
the estimated onset data indicate whether or not each of a plurality of chromas as a plurality of pitches that include the pitch corresponds to an onset, and
the performance analysis method further comprises, in response to a chroma corresponding to a pitch of a target note, which is one note specified by the music data, and a chroma related to an onset represented by the estimated onset data being different, displaying a performance image that corresponds to the onset represented by the estimated onset data at a position on a pitch axis that is set with a time axis in a score area, the position corresponding to a pitch which is closest to the pitch of the target note among the plurality of pitches belonging to the chroma related to the onset represented by the estimated onset data.

7. An estimation model construction device comprising:
an electronic controller including at least one processor, the electronic controller being configured to execute a plurality of modules including
a training data preparation module configured to prepare a plurality of training data that include
first training data that include first feature amount data that represent a first feature amount of a performance sound of a musical instrument, and first onset data that represent a pitch at which an onset exists, and
second training data that include second feature amount data that represent a second feature amount of a sound generated by a sound source of a type different than the musical instrument, and second onset data that represent that an onset does not exist, and
an estimation model construction module configured to construct, by machine learning using the plurality of training data, an estimation model that estimates, from a feature amount data that represent a feature amount of a performance sound of the musical instrument, estimated onset data that represent a pitch at which an onset exists.

8. The estimation model construction device according to claim 7, wherein
the training data preparation module is configured to prepare the plurality of training data such that by applying, to an audio signal that represents the performance sound of the musical instrument, a transmission characteristic from the musical instrument to a sound collection point, the first training data includes the first feature amount data that represent the first feature amount extracted from the audio signal after the applying and the first onset data.

9. A performance analysis device comprising:
the electronic controller configured to further execute
an onset estimation module configured to sequentially estimate, from the feature amount data that represent the feature amount of a performance sound of a musical piece from the musical instrument, the estimated onset data, by using the estimation model constructed by the estimation model construction device according to claim 7, and
a performance analysis module configured to analyze a performance of the musical piece by matching music data that specify a time series of notes that constitute the musical piece and a time series of the estimated onset data estimated by the estimation model.

10. The performance analysis device according to claim 9, wherein
the music data specify a time series of notes that constitute a first performance part of the musical piece and a time series of notes that constitute a second performance part of the musical piece,
the performance analysis module is configured to perform, in accordance with the estimated onset data, determination whether or not a note indicated by a first pointer, in the time series of notes specified by the music data with respect to the first performance part, has been sounded by the musical instrument, and configured to advance the first pointer to a next note of the first performance part in response to an affirmative result of the determination, and
the performance analysis module is configured to perform, in accordance with the estimated onset data, determination whether or not a note indicated by a second pointer, in the time series of notes specified by the music data with respect to the second performance part, has been sounded by the musical instrument, and configured to advance the second pointer to a next note of the second performance part in response to an affirmative result of the determination.

11. The performance analysis device according to claim 9, wherein
the performance analysis module is configured to determine whether or not a pitch of a target note, which is one note specified by the music data, and a pitch that corresponds to an onset represented by the estimated onset data are the same or different, and whether a starting point of the target note is before or after the onset represented by the estimated onset,
the electronic controller is configured to further execute a display control module configured to display a note image that represents the target note in a score area in which a time axis and a pitch axis are set, and
the display control module is configured to display a first image in a negative direction of the time axis with respect to the note image upon determining that the onset represented by the estimated onset data is located before the starting point of the target note, and display a second image in a positive direction of the time axis with respect to the note image upon determining that the onset represented by the estimated onset data is located after the starting point of the target note.

12. The performance analysis device according to claim 9, wherein
the estimated onset data indicate whether or not each of a plurality of chromas as a plurality of pitches that include the pitch corresponds to an onset, and
the electronic controller is configured to further execute a display control module configured to, in response to a chroma corresponding to a pitch of a target note, which is one note specified by the music data, and a chroma related to an onset represented by the estimated onset data being different, display a performance image that corresponds to the onset represented by the estimated onset data at a position on a pitch axis that is set with a time axis in a score area, the position corresponding to a pitch which is closest to the pitch of the target note among the plurality of pitches belonging to the chroma related to the onset represented by the estimated onset data.
